(19) United States
(12) Patent Application Publication
(10) Pub. No.: US 2023/0300312 A1
(43) Pub. Date: Sep. 21, 2023

(54) OMNIDIRECTIONAL IMAGE-CAPTURING ASSEMBLY AND METHOD EXECUTED BY SAME

(71) Applicant: 31 INC., Daegu (KR)

(72) Inventors: Gyu Hyon KIM, Seoul (KR); Ji Wuck JUNG, Goyang-si (KR)

(21) Appl. No.: 18/018,573

(22) PCT Filed: Jun. 24, 2021
(86) PCT No.: PCT/KR2021/007928

§ 371 Date: Jan. 29, 2023

(30) Foreign Application Priority Data
Jul. 31, 2020 (KR) 10-2020-0095734

(51) Int. Cl. H04N 13/282; H04N 13/172; H04N 13/271; H04N 13/194; G03B 17/56

(52) U.S. Cl. CPC H04N 13/282; H04N 13/172; H04N 13/271; H04N 13/194; G03B 17/561

(57) ABSTRACT

An omnidirectional image-capturing assembly for conveniently generating virtual tours conducted via omnidirectional images, and a method executed thereby includes an omnidirectional image-capturing assembly having an omnidirectional image-capturing apparatus, a mobile computing apparatus, and a mobile stand for fixing the omnidirectional image-capturing apparatus and mobile computing apparatus.

This application is a National Stage Entry of PCT/KR2021/007928, filed on Jun. 24, 2021, and claims priority from and the benefit of Korean Patent Application No. 10-2020-0095734, filed on Jul. 31, 2020, each of which is hereby incorporated by reference for all purposes as if fully set forth herein.

### BACKGROUND

### Field

Embodiments of the invention relate generally to an omnidirectional image capturing assembly and a method performed by the same, and more specifically, to an omnidirectional image capturing assembly for conveniently generating a virtual tour represented by an omnidirectional image, and a method performed by the same.

### Discussion of the Background

Recently, technologies related to virtual tours of specific spaces have emerged. An example of the technologies is a virtual tour that allows a user to move to a specific position inside an indoor space of a building such as an apartment and view an image shot at the moved position so that the user may experience the indoor space as if it were real. In order to create such a virtual tour, it is necessary to correctly establish a positional relationship between images inside the space to reflect structural characteristics of the space. In other words, in order to form a virtual tour that matches the actual reality, it is necessary to identify the exact position where each image was shot and match it to the image, which in the past was cumbersome for the filming personnel to do manually.

On the other hand, technologies for phase mapping between different images are widely known. Phase mapping may be a technology for identifying relative positional relationships between different images or for connecting (or matching) images.

In general, in order to connect different images, a method of detecting a feature point from each of two images containing a common space and transforming and connecting the images through a transformation function (a transformation matrix) that allows the detected feature points to overlap so as to have the least error is used.

In addition, technical ideas using matching points that exist in each of two images (e.g., points in two different images corresponding to the same point in space) to determine the positional relationship between the two images even if the images are not connected (matched) have been known.

However, there may be cases where there are a plurality of images and it is not known which of these images should be connected to each other or which images are images that can be mapped to each other (e.g., images containing the same space). In other words, such a case may be the case where the position and/or direction of each of the images is not known.

For example, when an image (e.g., a 360 degree image) is shot at each of a plurality of different positions in the indoor space, various services such as navigation of the indoor space may be smoothly accomplished by specifying the positional relationship of respective images. However, while the position where each image was shot is unknown, it is not possible to know which images can be mapped to each other.

In this case, it should be determined whether each combination of images can be mapped to each other. However, these tasks may be very resourceful and time-consuming. For example, in order to find an image pair that can be mapped to each other when there are five different images, the first image may be set as a pair with the second image to the fifth image, respectively, to determine whether the images can be mapped to each other. For example, the image in which feature points in common with the first image are found the most may be an image mapped with the first image. This is because the images mapped to each other are cases where there is an area where the common space is shot, and the same feature points may be found in the area where the common space is shot.

Only by performing this task for each of all image pairs can the phase relationship between the images be determined, and then mapping between images adjacent to each other can be performed. In this specification, mapping may be a case of matching two images when they can be connected (matched), but when they do not need to be connected (matched), such as images shot at two different positions, it can be defined as including identifying the relative positional relationship between the two images.

As the number of images increases, the cost required to identify images that can be mapped and to specify the positional relationship between the identified images increases exponentially.

Therefore, a technical object to be achieved by the present disclosure is to provide a technical idea that allows an image shot at each position inside a specific space to correspond to an exact position in which the image has been shot.

Further, an object of the present disclosure is to provide a method and system for quickly and effectively performing mapping between a plurality of images shot inside a building.

The above information disclosed in this Background section is only for understanding of the background of the inventive concepts, and, therefore, it may contain information that does not constitute prior art.

### SUMMARY

In accordance of one aspect of the present disclosure, there is provided an omnidirectional image capturing assembly including an omnidirectional image capturing apparatus; a mobile computing apparatus; and a movable holder for fixing the omnidirectional image capturing apparatus and the mobile computing apparatus, wherein the mobile computing apparatus includes: a communication module for communicating with the omnidirectional image capturing apparatus; a tracking module configured to track a position of the mobile computing apparatus; a control module configured to acquire, when an image is shot by the omnidirectional image capturing apparatus, position information of the mobile computing apparatus at the time of shooting; and a storage module configured to store a shot image shot by the omnidirectional image capturing apparatus and the position information of the mobile computing apparatus at the time of shooting of the shot image.

In one embodiment, the tracking module may be configured to further track a posture of the mobile computing apparatus, the control module may be configured to acquire posture information of the mobile computing apparatus, when an image is shot by the omnidirectional image capturing apparatus, at the time of shooting, and the storage module may be configured to further store the posture information of the mobile computing apparatus at the time of shooting of the shot image.

In one embodiment, the mobile computing apparatus may include a camera module, the omnidirectional image capturing apparatus and the mobile computing apparatus may be installed on the movable holder such that a shooting direction of a front camera module included in the omnidirectional image capturing apparatus and a shooting direction of the camera module included in the mobile computing apparatus coincide within a predetermined error range, and the tracking module may be configured to track the position and posture of the mobile computing apparatus by performing Visual Simultaneous Localization and Mapping (VSLAM) on an image shot by the camera module.

In one embodiment, the mobile computing apparatus may further include a transmission module configured to transmit to a predetermined server an information set including an omnidirectional image generated by stitching a plurality of partial shot images shot by the omnidirectional image capturing apparatus and position information of the mobile computing apparatus at the time when the plurality of partial shot images are shot, and the server may be configured to determine, when receiving a plurality of information sets corresponding to different positions within a predetermined indoor space from the mobile computing apparatus, a connection relationship between a plurality of omnidirectional images included in the plurality of information sets wherein at least two of the plurality of omnidirectional images have a common area in which a common space is shot.

In one embodiment, the mobile computing apparatus may further include a transmission module configured to transmit to a predetermined server an information set including a plurality of partial shot images shot by the omnidirectional image capturing apparatus and position information of the mobile computing apparatus at the time when the plurality of partial shot images are shot, and the server may be configured to generate an omnidirectional image corresponding to the information set when receiving the information set from the mobile computing apparatus, by stitching the plurality of partial shot images included in the information set, and when receiving a plurality of information sets corresponding to different positions in a predetermined indoor space from the mobile computing apparatus to generate an omnidirectional image corresponding to each of the plurality of information sets corresponding to the different positions in the indoor space, determine a connection relationship between the plurality of omnidirectional images, wherein at least two of the plurality of omnidirectional images have a common area in which a common space is shot.

In one embodiment, the server may be configured to extract features from each of the plurality of omnidirectional images through a feature extractor using a neural network and determine a mapping image of each of the plurality of omnidirectional images based on the features extracted from each of the plurality of omnidirectional images, in order to determine the connection relationship between the plurality of omnidirectional images.

In one embodiment, the information set may be in the form of JavaScript Object Notation.

In one embodiment, the mobile computing apparatus may be installed on a rotating body rotating with a mounting rod of the movable holder as a rotating axis, and may further include: a camera module; and a rotating body control module configured to control rotation of the rotating body, and the rotating body control module may be configured to control the rotation of the rotating body such that a shooting direction of a front camera module included in the omnidirectional image capturing apparatus and a shooting direction of the camera module included in the mobile computing apparatus coincide within a predetermined error range.

In one embodiment, the rotating body control module may be configured to control the rotation of the rotating body based on an image shot by the front camera module included in the omnidirectional image capturing apparatus and an image shot by the camera module included in the mobile computing apparatus.

In accordance of another aspect of the present disclosure, there is provided a mobile computing apparatus installed on a movable holder including a communication module for communicating with an omnidirectional image capturing apparatus installed on the movable holder;
a tracking module configured to track a position of the mobile computing apparatus; a control module configured to acquire, when an image is shot by the omnidirectional image capturing apparatus, position information of the mobile computing apparatus at the time of shooting; and a storage module configured to store a shot image shot by the omnidirectional image capturing apparatus and the position information of the mobile computing apparatus at the time of shooting of the shot image.

In accordance with another aspect of the present disclosure, a method performed by a mobile computing apparatus installed on a movable holder, including an operation of establishing connection for wireless communication with an omnidirectional image capturing apparatus installed on the movable holder; a tracking operation of tracking a position of the mobile computing apparatus; an information acquisition operation of acquiring, when an image is shot by the omnidirectional image capturing apparatus, position information of the mobile computing apparatus at the time of shooting; and a storage operation of storing a shot image shot by the omnidirectional image capturing apparatus and the position information of the mobile computing apparatus at the time of shooting of the shot image.

In one embodiment, the tracking operation may include tracking a posture of the mobile computing apparatus, the information acquisition operation may include acquiring, when the image is shot by the omnidirectional image capturing apparatus, posture information of the mobile computing apparatus at the time of shooting, and the storage operation may include storing the posture information of the mobile computing apparatus at the time of shooting of the shot image.

In one embodiment, the mobile computing apparatus may include a camera module, the omnidirectional image capturing apparatus and the mobile computing apparatus may be installed on the movable holder such that a shooting direction of a front camera module included in the omnidirectional image capturing apparatus and a shooting direction of the camera module included in the mobile computing apparatus coincide within a predetermined error range, and the tracking operation may include tracking the position and posture of the mobile computing apparatus by performing Visual Simultaneous Localization and Mapping (VSLAM) on an image shot by the camera module.

In one embodiment, the method may further include transmitting to a predetermined server an omnidirectional image generated by stitching a plurality of partial shot images shot by the omnidirectional image capturing apparatus and an information set including position information of the mobile computing apparatus at the time when the plurality of partial shot images are shot, and the server may be configured to determine, when receiving from the mobile computing apparatus a plurality of information sets corresponding to different positions in a predetermined indoor space, a connection relationship between a plurality of omnidirectional images included in the plurality of information sets, wherein at least two of the plurality of omnidirectional images have a common area in which a common space is shot.

In one embodiment, the method may further include transmitting to a predetermined server an information set including a plurality of partial shot images shot by the omnidirectional image capturing apparatus and the position information of the mobile computing apparatus at the time of shooting of the plurality of partial shot images, and the server may be configured to generate an omnidirectional image corresponding to the information set when receiving the information set from the mobile computing apparatus, by stitching the plurality of partial shot images included in the information set, and when receiving a plurality of information sets corresponding to different positions in a predetermined indoor space from the mobile computing apparatus to generate an omnidirectional image corresponding to each of the plurality of information sets corresponding to the different positions in the indoor space, determine a connection relationship between the plurality of omnidirectional images, wherein at least two of the plurality of omnidirectional images have a common area in which a common space is shot.

In one embodiment, the mobile computing apparatus may be installed on a rotating body rotating with a mounting rod of the movable holder as a rotating axis, the mobile computing apparatus may include a camera module, and the method may further include a rotating body control operation of controlling rotation of the rotating body, and wherein the rotating body control operation may include controlling the rotation of the rotating body such that a shooting direction of a front camera module included in the omnidirectional image capturing apparatus and a shooting direction of the camera module included in the mobile computing apparatus coincide within a predetermined error range.

In one embodiment, the rotating body control operation may include controlling the rotation of the rotating body based on an image shot by the front camera module included in the omnidirectional image capturing apparatus and an image shot by the camera module included in the mobile computing apparatus.

In accordance with another aspect of the disclosure, there is provided a non-transitory computer-readable recording medium in which a program for performing the above-described method is recorded.

In accordance with another aspect of the disclosure, there is provided a mobile computing apparatus including a processor; and a memory in which a program is stored, wherein the program, when executed by the processor, causes the mobile computing apparatus to perform the above-described method.

According to an embodiment of the present disclosure, it is possible to match an image shot at each position inside a specific space with an exact position in which the image has been shot.

In addition, it is possible to provide a system and method for quickly and effectively performing mapping between a plurality of images shot inside a building.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a diagram illustrating an example of an omnidirectional image capturing assembly according to an embodiment of the present disclosure.

FIG. 2 is a diagram for schematically illustrating an operation between an omnidirectional image capturing assembly and a server according to an embodiment of the present disclosure.

FIG. 3 is a block diagram schematically illustrating a configuration of an omnidirectional image capturing apparatus according to an embodiment of the present disclosure.

FIG. 4 is a block diagram schematically illustrating a configuration of a mobile computing apparatus according to an embodiment of the present disclosure.

FIG. 5 is a plan view of a predetermined indoor space and an example of different shooting positions on the indoor space.

FIG. 6 shows a flowchart for illustrating an omnidirectional image processing method according to an embodiment of the present disclosure.

FIG. 7 is a flowchart illustrating an example of a process of acquiring an omnidirectional image corresponding to one shooting position.

FIG. 8 is a diagram for illustrating an automatic phase mapping processing method according to an embodiment of the present disclosure.

FIG. 9 is a schematic diagram illustrating a schematic configuration of an automatic phase mapping processing system according to an embodiment of the present disclosure.

FIG. 10 is a diagram for illustrating a concept of using a feature of a neural network for an automatic phase mapping processing method according to an embodiment of the present disclosure.

FIG. 11 is a diagram for schematic illustrating a logical configuration of an automatic phase mapping processing system according to an embodiment of the present disclosure.

FIG. 12 is a diagram for illustrating advantages of using a neural network feature according to an embodiment of the present disclosure.

FIG. 13 is a diagram for illustrating a feature position corresponding to a neural network feature according to an embodiment of the present disclosure.

FIG. 14 is a flowchart for illustrating a method of searching for mapping images between images in an automatic phase mapping processing method according to an embodiment of the present disclosure.

FIG. 15 is a flowchart for illustrating a method for mapping images in an automatic phase mapping processing method according to an embodiment of the present disclosure.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z—axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Various exemplary embodiments are described herein with reference to sectional and/or exploded illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not necessarily be construed as limited to the particular illustrated shapes of regions, but are to include deviations in shapes that result from, for instance, manufacturing. In this manner, regions illustrated in the drawings may be schematic in nature and the shapes of these regions may not reflect actual shapes of regions of a device and, as such, are not necessarily intended to be limiting.

As customary in the field, some exemplary embodiments are described and illustrated in the accompanying drawings in terms of functional blocks, units, and/or modules. Those skilled in the art will appreciate that these blocks, units, and/or modules are physically implemented by electronic (or optical) circuits, such as logic circuits, discrete components, microprocessors, hard-wired circuits, memory elements, wiring connections, and the like, which may be formed using semiconductor-based fabrication techniques or other manufacturing technologies. In the case of the blocks, units, and/or modules being implemented by microprocessors or other similar hardware, they may be programmed and controlled using software (e.g., microcode) to perform various functions discussed herein and may optionally be driven by firmware and/or software. It is also contemplated that each block, unit, and/or module may be implemented by dedicated hardware, or as a combination of dedicated hardware to perform some functions and a processor (e.g., one or more programmed microprocessors and associated circuitry) to perform other functions. Also, each block, unit, and/or module of some exemplary embodiments may be physically separated into two or more interacting and discrete blocks, units, and/or modules without departing from the scope of the inventive concepts. Further, the blocks, units, and/or modules of some exemplary embodiments may be physically combined into more complex blocks, units, and/or modules without departing from the scope of the inventive concepts.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

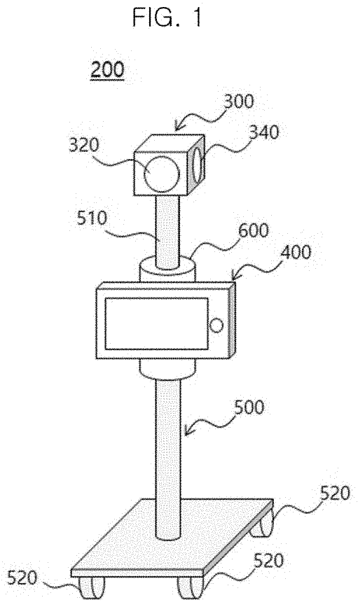

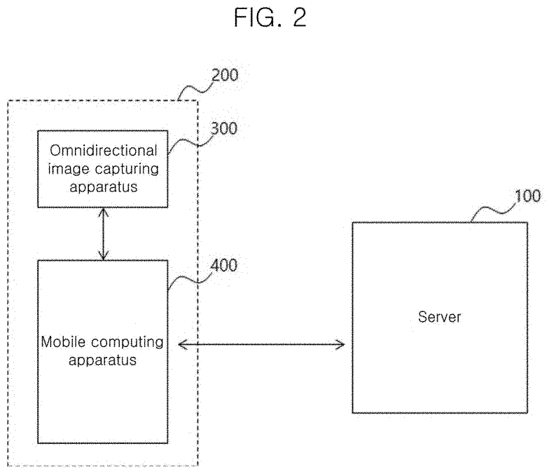

FIG. 1 is a diagram illustrating an example of an omnidirectional image capturing assembly according to an embodiment of the present disclosure, and FIG. 2 is a diagram for schematically illustrating an operation between the omnidirectional image capturing assembly and a server according to an embodiment of the present disclosure.

Referring to FIG. 1, an omnidirectional image capturing assembly 200 may include an omnidirectional image capturing apparatus 300, a mobile computing apparatus 400, and a movable holder 500.

The omnidirectional image capturing apparatus (an omnidirectional camera; 300), also called a 360-degree camera, may be an apparatus capable of shooting with a spherical angle of view or taking a plurality of partial images for generating an image having a spherical angle of view.

For example, the omnidirectional image capturing apparatus 300 may include four camera modules (e.g., 320 and 340) installed on the front/rear/left/right sides, respectively, and the images shot through these camera modules may be stitched to generate omnidirectional images. In addition, there may be various types of omnidirectional image capturing apparatuses, such as a type in which a camera module having a hemispherical angle of view is installed on the front/rear sides, respectively.

The camera modules (e.g., 320 and 340) provided in the omnidirectional image capturing apparatus 300 may include a fisheye lens.

The mobile computing apparatus 400 may include a mobile processing device such as a smartphone, tablet, or PDA.

The omnidirectional image capturing apparatus 300 and the mobile computing apparatus 400 may be installed on the movable holder 500. The movable holder 500 may include wheels 520 for moving forward, rearward, left and right, and may include a mounting means for mounting the omnidirectional image capturing apparatus 300 and the mobile computing apparatus 400.

In one embodiment, the movable holder 500 may further include a rotating body 600 rotating with a mounting rod 510 of the movable holder 510 as a rotating axis, and the mobile computing apparatus 400 may be installed on the rotating body 600. In another embodiment, the omnidirectional image capturing assembly 200 may also be implemented in a form in which the omnidirectional image capturing apparatus 300 is installed on the rotating body 600 instead of the mobile computing apparatus 400.

Referring to FIG. 2, the mobile computing apparatus 400 and the omnidirectional image capturing apparatus 300 are connected to each other through wired communication or wireless communication to transmit and receive various information, signals, and/or data necessary for realizing the technical idea of the present disclosure. For example, wireless communication may include a long-range mobile communication such as 3G, LTE, LTE-A, 5G, Wi-Fi, WiGig, Ultra Wide Band (UWB), and a LAN card, or a short-range wireless communication such as MST, Bluetooth, NFC, RFID, ZigBee, Z-Wave, and IR.

The mobile computing apparatus 400 may transmit a predetermined signal to the omnidirectional image capturing apparatus 300 to control the omnidirectional image capturing apparatus 300 to shoot. The omnidirectional image capturing apparatus 300 may transmit the shot image or images to the mobile computing apparatus 400.

In addition, the mobile computing apparatus 400 may be connected to a remote server 100 through wired/wireless communication (e.g., the Internet). The mobile computing apparatus 400 may transmit the image or images shot by the omnidirectional image capturing apparatus 300 to the server 100. The server 100 may perform an omnidirectional image processing method described below for the image or images transmitted from the mobile computing apparatus 400.

In addition, the mobile computing apparatus 400 may track its position and/or posture, and the omnidirectional image capturing apparatus 300 may further transmit position/posture information at the time of shooting an image or images to the server 100 together with the shot image or images.

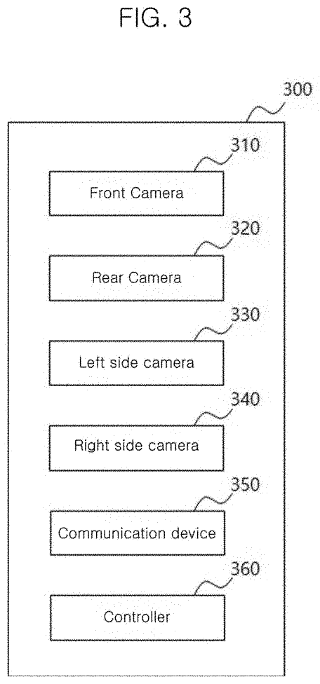

FIG. 3 is a block diagram schematically illustrating a configuration of the omnidirectional image capturing apparatus 300 according to an embodiment of the present disclosure.

Referring to FIG. 3, the omnidirectional image capturing apparatus 300 may include a front camera 310, a rear camera 320, a left side camera 330, a right side camera 340, a communication device 350, and a controller 360. According to an embodiment of the present disclosure, some of the above-described components may not necessarily be essential to implementation of the present disclosure, and according to an embodiment, the omnidirectional image capturing apparatus 300 may include more components.

The front camera 310, the rear camera 320, the left side camera 330, and the right side camera 340 may be installed on the front, rear, left, and right sides of the omnidirectional image capturing apparatus 300, respectively, and may include a fisheye lens.

Four partial images shot by the front camera 310, the rear camera 320, the left side camera 330, and the right side camera 340 may be synthesized into one omnidirectional image through stitching. Image stitching may be performed on the server 100, the omnidirectional image capturing apparatus 300, or the mobile computing apparatus 400.

According to an embodiment, the omnidirectional image capturing apparatus 300 may include at least a part of the front camera 310, the rear camera 320, the left side camera 330, and the right side camera 340. For example, the omnidirectional image capturing apparatus 300 may include only the front camera 310 and the rear camera 320.

The communication device 350 may perform wired/wireless communication with the mobile computing apparatus 400.

The controller 360 may control functions and/or resources of other elements of the omnidirectional image capturing apparatus 300 (e.g., the front camera 310, rear camera 320, left side camera 330, right side camera 340, communication device 350, etc.). The controller 360 may include a CPU, an APU, a mobile processing apparatus, and the like.

For example, when a predetermined signal is generated (for example, when receiving a predetermined shooting signal from the mobile computing apparatus 400), the controller may control the front camera 310, the rear camera 320, the left side camera 330, and the right side camera 340 to shoot images, and may control the communication device 350 to transmit the images shot by the mobile computing apparatus 400.

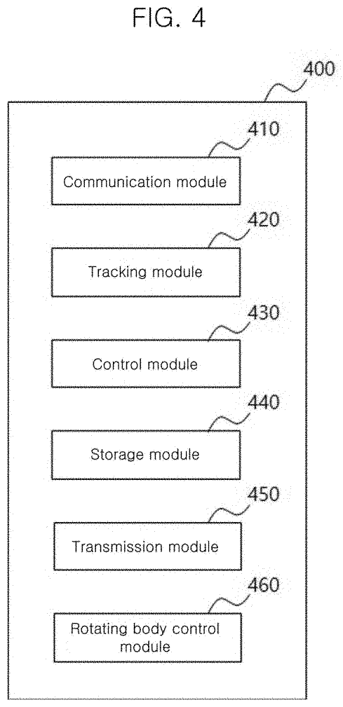

FIG. 4 is a block diagram schematically illustrating a configuration of the mobile computing apparatus 400 according to an embodiment of the present disclosure.

Referring to FIG. 4, the mobile computing apparatus 400 may include a communication module 410, a tracking module 420, a control module 430, a storage module 440, and a transmission module 450. According to an embodiment, the mobile computing apparatus 400 may further include a rotating body control module 460. According to an embodiment of the present disclosure, some of the above-described components may not necessarily be essential to the implementation of the present disclosure, and according to an embodiment, the mobile computing apparatus 400 may include more components.

In this specification, the term “module” may mean a functional and structural combination of hardware and software for driving the hardware for carrying out the technical idea of the present disclosure. For example, the module may mean a predetermined code and a logical unit of hardware resources for the predetermined code to be performed, and a person skilled in the art may easily infer that the module does not necessarily mean a physically connected code or does not mean one type of hardware.

The control module 430 may control functions and/or resources of other elements included in the mobile computing apparatus 400 (e.g., the communication module 410, tracking module 420, storage module 440, transmission module 450, etc.).

The communication module 410 may communicate with an external device and transmit and receive various signals, information, and data. For example, the communication module 410 may perform wired communication or wireless communication with the omnidirectional image capturing apparatus 300. The communication module 410 may include a long-distance communication module such as a 3G module, an LTE module, an LTE-A module, a Wi-Fi module, a WiGig module, an Ultra Wide Band (UWB) module, a LAN card, and the like, or a short-distance communication module such as an MST module, a Bluetooth module, an NFC module, an RFID module, a ZigBee module, a Z-Wave module, an IR module, and the like.

The tracking module 420 may track the position and/or posture of the mobile computing apparatus 400.

In one embodiment, the tracking module 420 may track the position and/or posture of the mobile computing apparatus 400 through Visual Simultaneous Localization and Mapping (VSLAM). To this end, the mobile computing apparatus 400 may further include a camera module, and may track the position and posture of the mobile computing apparatus 400 by performing VSLAM on an image shot by the camera module. In this case, the omnidirectional image capturing apparatus 300 and the mobile computing apparatus 400 may be installed on the movable holder 200 such that a shooting direction of the front camera 310 included in the omnidirectional image capturing apparatus 300 and a shooting direction of the camera module included in the mobile computing apparatus 400 coincide within a predetermined error range.

In addition, according to an embodiment, the tracking module 420 may track the position of the mobile computing apparatus 400 in various ways. For example, the tracking module 420 may track the position of the mobile computing apparatus 400 through various Wi-Fi or Bluetooth-based indoor positioning technologies, and may track the position and/or posture of the mobile computing apparatus 400 through an IMU and/or a speed sensor embedded in the mobile computing apparatus 400.

The control module 430 may control a predetermined shooting signal to be transmitted to cause the omnidirectional image capturing apparatus 300 to shoot an image, and in response, when the omnidirectional image capturing apparatus 300 shoots an image, position information and/or posture information of the mobile computing apparatus 400 at the time of shooting may be acquired.

For example, the control module 430 may acquire the position information and/or posture information of the mobile computing apparatus 400 based on a time point when the shooting signal is transmitted or when the image shot from the omnidirectional image capturing apparatus 300 is received.

In addition, the storage module 440 may store a shot image shot by the omnidirectional image capturing apparatus 300 and the position information and/or posture information of the mobile computing apparatus at the time when the shot image is shot.

The transmission module 450 may transmit predetermined information to the server 100 through a wired/wireless communication network (e.g., the Internet). For example, the transmission module 450 may transmit an information set including a plurality of partial shot images shot by the omnidirectional image capturing apparatus 300 and the position information and/or posture information of the mobile computing apparatus 400 at the time when the plurality of partial shot images are shot to the server 100.

In one embodiment, the information set may be in the form of JavaScript Object Notation.

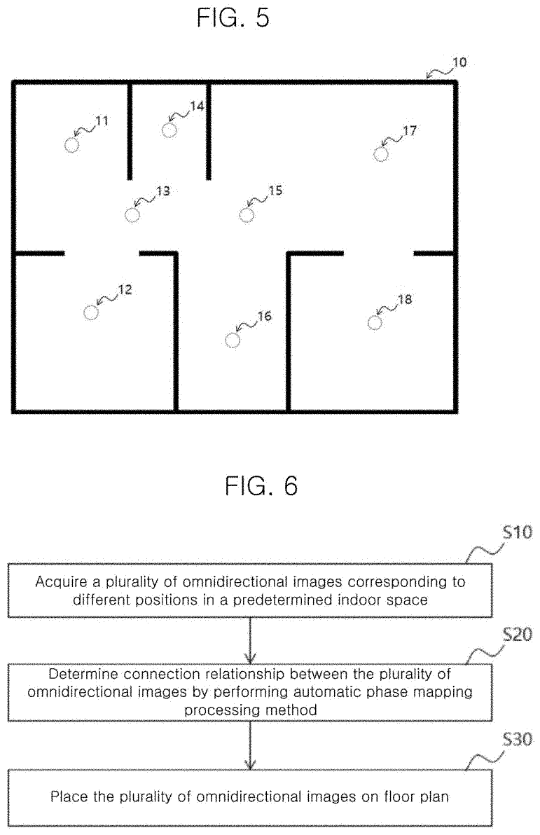

The imaging assembly 200 allows the server 100 to shoot an omnidirectional image (or a plurality of partial images for generating an omnidirectional image) at various different places in a predetermined indoor space, and transmits the shot image to the server so that the server may perform an omnidirectional image processing method (described below) targeting a plurality of omnidirectional images, which will be described with reference to FIG. 5.

FIG. 5 is a plan view of a predetermined indoor space and an example of different shooting positions on the indoor space. Referring to FIG. 5, the omnidirectional image capturing assembly 200 may move in turn to various different positions 11 to 18 on an indoor space 10. At each of positions 11 to 18, the omnidirectional image capturing apparatus 300 installed in the omnidirectional image capturing assembly 200 may shoot a plurality of partial shot images corresponding to the positions, and the mobile computing apparatus 300 may transmit the partial shot image shot at each of positions 11 to 18 to the server 100 along with information about the position at which the image was shot and/or the posture of the mobile computing apparatus 200. As a result, the server 100 may receive information set corresponding to each of position 11 to position 18, and for example, the information set corresponding to position 11 may include a plurality of partial images shot at position 11, information of position 11, and posture information of the mobile computing apparatus 300 at the time of shooting at position 11.

Referring again to FIG. 4, the rotating body control module 460 may control rotation of the rotating body 600 so that the shooting direction of the front camera 210 included in the omnidirectional image capturing apparatus 200 and the shooting direction of the camera module included in the mobile computing apparatus 300 coincide within a predetermined error range.

In one embodiment, the rotating body control module 460 may control the rotation of the rotating body 600 based on the image shot by the front camera 210 included in the omnidirectional image capturing apparatus 200 and the image shot by the camera module included in the mobile computing apparatus 300.

As described above, the server 100 may perform the omnidirectional image processing method. The omnidirectional image processing method may be a method of determining a connection relationship between a plurality of omni-directional images corresponding to different respective positions in a predetermined indoor space. In this case, at least two of the plurality of omnidirectional images may have a common area in which a common space is shot. This may mean that each of the plurality of omnidirectional images shares a shooting space with at least one of the remaining omnidirectional images, wherein that the two images share the shooting space may mean that at least a part of the spaces shot in the two images overlaps.

Hereinafter, the omnidirectional image processing method performed by the server 100 will be described in detail.

FIG. 6 shows a flowchart for illustrating an omnidirectional image processing method according to an embodiment of the present disclosure performed by the server 100.

Referring to FIG. 6, the server 100 may acquire a plurality of omni-directional images corresponding to different respective positions in a predetermined indoor space (S10).

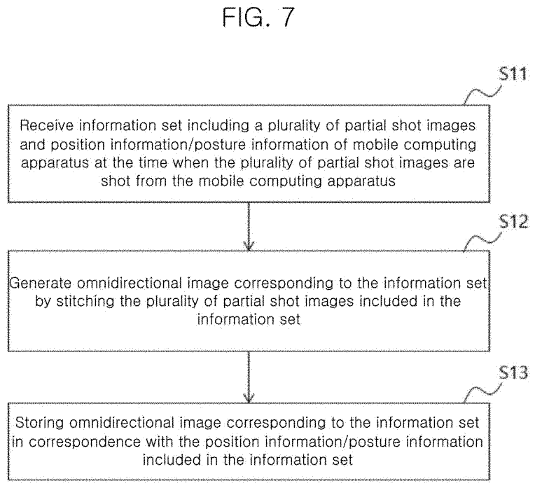

In one embodiment, based on the plurality of partial shot images received from the mobile computing apparatus 400, the server 100 may acquire an omnidirectional image corresponding to the plurality of partial shot images (S10). A detailed process of this is shown in FIG. 7. FIG. 7 is a flowchart illustrating an example of a process of acquiring an omnidirectional image corresponding to one shooting position.

Referring to FIG. 7, the server 100 may receive the information set including the plurality of partial shot images and the position information and/or posture information of the mobile computing apparatus at the time when the plurality of partial shot images are shot from the mobile computing apparatus 400 in order to acquire an omnidirectional image (S11), and may generate an omnidirectional image corresponding to the information set by stitching the plurality of partial shot images included in the information set (S12).

For example, the server 100 may generate the omnidirectional image by performing image stitching for a front shot image, a rear shot image, a left shot image, and a right shot image (which are included in the information set) shot by the omnidirectional image capturing apparatus 200 from the mobile computing apparatus 400.

Thereafter, the server 100 may store the omnidirectional image corresponding to the information set in correspondence with the position information and/or posture information included in the information set (S13).

Meanwhile, in another embodiment, image stitching may be performed in the mobile computing apparatus 400. In this embodiment, the mobile computing apparatus 400 may receive the plurality of partial shot images from the omnidirectional image capturing apparatus 300, and may generate an omnidirectional image by stitching the received plurality of partial shot images. In this case, the mobile apparatus 400 may transmit the stitched omnidirectional image and the information set including the position information and/or posture information of the mobile computing apparatus 400 at the time when the plurality of partial shot images are shot to the server 100.

In another embodiment, image stitching may be performed in the omnidirectional image capturing apparatus 300. In this case, the omnidirectional image capturing apparatus 300 may generate an omnidirectional image by stitching the plurality of partial shot images and then transmit it to the mobile computing apparatus 400. Then, the mobile computing apparatus may transmit information set including the received omnidirectional image and the position information and/or posture information of the mobile computing apparatus 400 at the time when the plurality of partial shot images are shot to the server 100.

Referring again to FIG. 6, the server may determine a connection relationship between a plurality of omnidirectional images (S20).

In one embodiment, the server 100 may determine the connection relationship between the plurality of omnidirectional images based on the order in which each of the plurality of omnidirectional images is received or generated. More specifically, when an omnidirectional image is received or generated, the server 100 may determine that the omnidirectional image and an omnidirectional image received or generated next are connected. This is because the plurality of omnidirectional images or partial shot images used to generate them are shot in sequence while the above-described omnidirectional image capturing assembly 200 moves. For example, when omnidirectional image 1 to omnidirectional image 5 are received or generated sequentially, the server 100 determines that the omnidirectional image 1 and the omnidirectional image 2 are connected, the omnidirectional image 2 and the omnidirectional image 3 are connected, the omnidirectional image 3 and the omnidirectional image 4 are connected, and the omnidirectional image 4 and the omnidirectional image 5 are connected.

In another embodiment, the server 100 may perform an automatic phase mapping processing method described below to determine a connection relationship between a plurality of omnidirectional images with each other. Hereinafter, an automatic phase mapping processing method according to the technical spirit of the present disclosure and the server 100 performing the same will be described in detail.

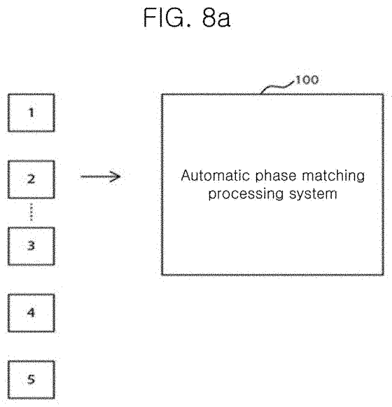

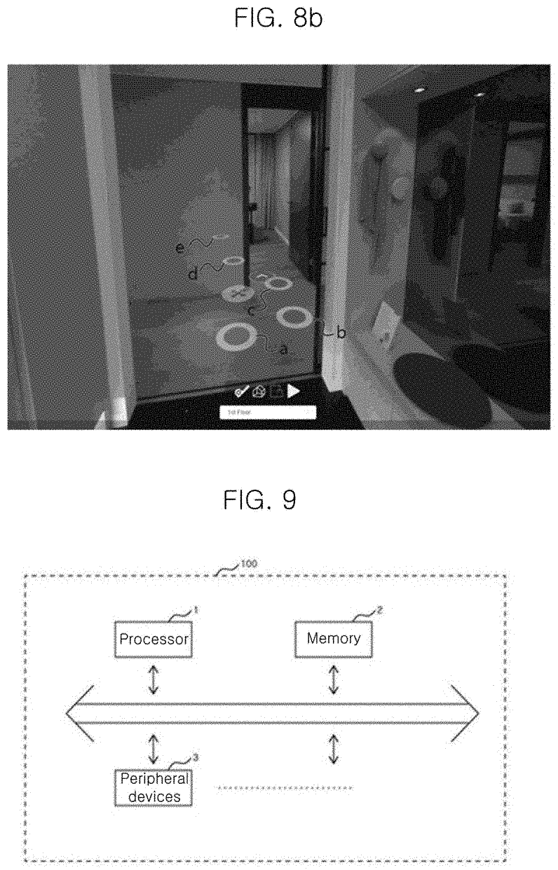

FIG. 8 is a schematic diagram for implementing an automatic phase mapping processing method according to an embodiment of the present disclosure. In addition, FIG. 9 is a schematic diagram illustrating a schematic configuration of the server 100 for performing the automatic phase mapping processing method according to an embodiment of the present disclosure.

The server 100 may include a memory 2 in which a program is stored for implementing the technical idea of the present disclosure, and a processor 1 for executing the program stored in the memory 2.

An average expert in the art of the present disclosure will be able to easily infer that, according to an implementation of the server 100, the processor 1 may be named by various names such as a CPU and mobile processor.

The memory 2 may be implemented as any type of storage device in which the program is stored and which is accessible by the processor to drive the program. In addition, according to a hardware implementation, the memory 2 may be implemented as a plurality of storage devices rather than a single storage device. In addition, the memory 2 may include not only a main memory device but also a temporary storage device. It may also be implemented as a volatile memory or a nonvolatile memory, and may be defined as including all types of information storage means implemented so that the program may be stored and driven by the processor.

The server 100 may be implemented in various ways such as a web server, a computer, a mobile phone, a tablet, a TV, a set-top box, and the like, and may be defined as including any type of data processing apparatus capable of performing the function defined herein.

In addition, according to an embodiment of the server 100, various peripheral devices 3 may be further provided. For example, an average expert in the art of the present disclosure will easily infer that a keyboard, a monitor, a graphics card, a communication device, and the like may be further included in the automatic phase mapping processing system 100 as peripheral devices.

Hereinafter, for convenience of understanding, the server 100 performing the automatic phase mapping processing method will be referred to as the automatic phase mapping processing system 100.

The automatic phase mapping processing system 100 according to the technical spirit of the present disclosure may identify images that can be mapped to each other among a plurality of images, in other words, mapping images. In addition, according to an embodiment, the automatic phase mapping processing system 100 may perform mapping between the identified mapping images.

The mapping images may mean images having the closest phase relationship to each other. The closest phase relationship may include a case where not only the distance is close but also spatially they must be able to move directly with each other, and an example may be images containing the most common space. In addition, performing mapping may mean matching between two images as described above, but in the present disclosure, identification of the phases of the two images, in other words, a relative positional relationship, will be mainly described.

For example, as shown in FIG. 8A, the automatic phase mapping processing system 100 may receive a plurality of images (e.g., five) images. Then, the automatic phase mapping processing system 100 may identify which images can be mapped to each other among the plurality of images, in other words, mapping images, and perform mapping of the identified mapping images.

For example, in an embodiment of the present disclosure, the images may be omnidirectional images (i.e., 360 degree images) shot at different positions. Further, the mapping images may be pairs of images that share the most common space with each other.

For example, as shown in FIG. 8B, each of images shot at positions a, b, c, d, and e may be image 1, image 2, image 3, image 4, and image 5.

In this case, image 1, image 2, and image 3 contain a considerable amount of common space in the shot images, but image 1 and image 2 may contain more common space. Thus, the mapping image of image 1 may be image 2.

Then, the mapping image should be searched for image 2, and image 1, image 1 for which the mapping image has already been determined may be excluded. Then, the mapping image of image 2 may be image 3.

In this manner, the mapping image of image 3 may be image 4, and the mapping image of image 4 may be image 5.

The automatic phase mapping processing system 100 may then perform mapping to image 2, which is the mapping image based on image 1. The phase of image 2 to image 1, in other words, the position of image 2 relative to image 1 may be determined. Further, by sequentially identifying the phase of image 3 to image 2, the phase of image 4 to image 3, and the phase of image 5 to image 4, the phase relationship between the entire images may be specified.

As a result, conventionally, when there are a plurality of omnidirectional images and the exact position of each of the omnidirectional images is unknown, considerable time and resources may be required to identify positional relationships of the plurality of images.

For example, according to a conventional method, a predetermined feature point should be extracted for every image, and the extracted feature points should be used to determine how many feature points are common for each pair of images. In addition, a pair of images with the largest number of common feature points may be identified as mapping images with each other, and the mapping, in other words, the relative positional relationship may be determined according to the positions of the common feature points. If matching is required, a transformation matrix may be determined to overlap common feature points with minimal error, and the two images may be connected (matched) through transformation of either image through this transformation matrix.

However, the feature point used in this conventional method takes a considerable amount of time and computation to extract the feature point. In addition, in order to identify the mapping image, an operation of comparing feature points for each pair of images should be performed, and the larger the number of feature points of the images, the more this operation takes a considerable amount of time.

However, according to the technical idea of the present disclosure as described above, it is possible to quickly and accurately and automatically search for mapping images among such plurality of images and perform mapping to the searched mapping images.

In order to solve this problem, the automatic phase mapping processing system 100 according to the technical spirit of the present disclosure may use a neural network feature.

The neural network feature defined herein may mean all or a part of features selected in a feature map of a given layer of a neural network trained to achieve a predetermined object.

These features are used in a neural network (e.g., a convolutional neural network) trained to achieve a specific purpose and may be information derived by the trained neural network when the neural network is trained to achieve the specific purpose.

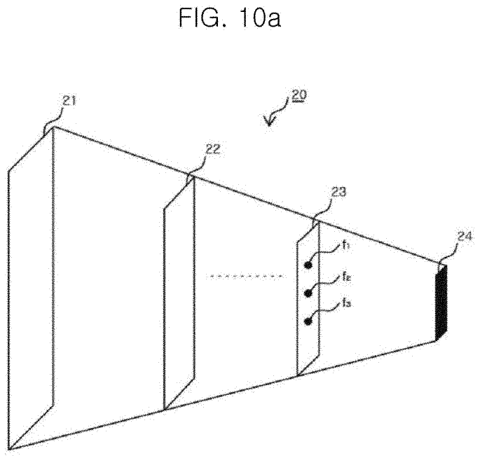

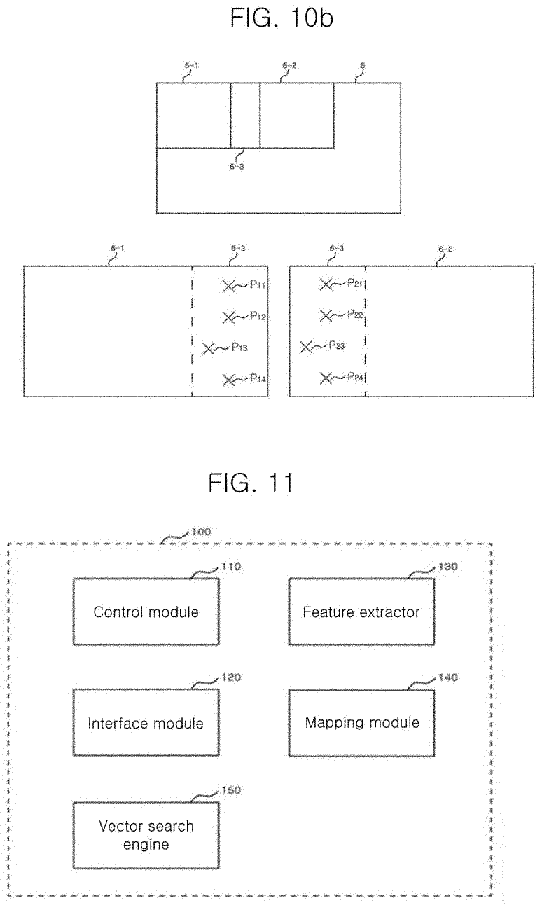

For example, there may be a neural network 20 as shown in FIG. 10A, and the neural network may be a convolutional neural network (CNN).

In this case, a plurality of layers 21, 22, 23, and 24 may be included in the neural network 20, and an input layer 21, an output layer 24, and a plurality of hidden layers 22 and 23 may exist. The output layer 24 may be a layer fully connected to the previous layer, and the automatic phase mapping processing system 100 according to the technical spirit of the present disclosure may select neural network features f1, f2, and f3 from the output layer 24 or the layer in which any feature map prior to the fully connected layer is included (e.g., 23).

The neural network features f1, f2, and f3 used by the automatic phase mapping processing system 100 may be all features included in the feature map of the corresponding layer, or some features selected among them.

The automatic phase mapping processing system 100 may use such features instead of conventional handcraft feature points, such as Scale-Invariant Feature Transform (SIFT), Speeded Up Robust Features (SURF), or Oriented FAST and Rotated BRIEF (ORB) to identify mapping images or perform mapping between the mapping images. In other words, the features used in the convolutional neural network may be used instead of conventional handcraft features.

It is preferable that the features of the image should have the same characteristics regardless of scale or orientation, and the layer prior to the output layer 23 in the convolutional neural network has this property through a plurality of nonlinear convolution functions and/or pooling functions. Moreover, the conventional handcraft features are extracted only at human-defined characteristic positions such as edges in the image, and have a property of being usually extracted only where the edges exist (for example, the edge bends, etc.).

However, the neural network feature has the advantage that the neural network 20 may be trained so that it can be found not at this position but in a flat area of the image. In addition, the handcraft features are often not detected even though the feature points should be detected according to image distortion or image quality, whereas neural network features are much more resistant to such image distortion, so there may be improvements in accuracy in feature extraction.

The neural network 20 may itself be a feature extractor. For example, when a feature is selected from the output layer 24 or the layer 23 immediately before the fully connected layer, the output layer 24 may be designed to output the selected features f1, f2, and f3 itself of the immediately preceding layer 23, and in this case, the neural network 20 itself may act as the feature extractor.

Or the neural network 20 may be trained to achieve a distinct unique purpose (e.g., classification, object detection, etc.). Even in this case, it is possible to always select a consistent feature on a given layer to use it as the neural network feature. For example, in the case of FIG. 10A, the coupling of the remaining layers except the output layer 24 may operate as the feature extractor.

According to an embodiment of the present disclosure, the neural network 20 may be a neural network trained to derive an optimal transformation relationship so that any one image is divided such that overlapping regions exist and then corresponding points extracted from the overlapping common areas of each of the divided images can be matched (e.g., an error is minimized).

For example, as shown in FIG. 10B, all or a part of a given image 6 may be divided so that there is an overlapping common area 6-3. Further, from each of the divided images 6-1 and 6-2, points of a predetermined number corresponding to each other (e.g., P11 to P14, P21 to P24) may be extracted.

Then, a neural network trained so that the points P11 to P14 extracted from the first division image 6-1 and the points P21 to P24 extracted from the second division image 6-2 can be transformed with a minimum error (e.g., to determine parameters of the transformation matrix) may be implemented as the neural network 20.

In this case, the points (e.g., P11 to P14, P21 to P24) may be randomly selected points, or feature points extracted in a predetermined manner in the common area of each image.

In any case, all or a part of the well-trained neural network 20 may be used as the feature extractor to select and extract features from the image to achieve a given purpose.

The same feature may be extracted in the common area included in each of the different images input by the automatic phase mapping processing system 100 using this feature extractor. Therefore, the image in which the same features (corresponding features) exists the most in any one image can be determined as the mapping image.

On the other hand, according to the technical idea of the present disclosure, since the neural network features are represented as vectors, faster determination of the positional relationship is possible, not by comparing features for each pair of images as conventionally to search for a mapping image of a specific image, but by using a vector search engine capable of high-speed operation.

Techniques for searching large quantities of vectors at high speeds have recently been widely disclosed.

The vector search engine may be an engine built to quickly find vectors that are most similar (closest) to an input vector (or vector set). All vectors are indexed on and stored in a DB, and the vector search engine may be designed to output the vector (or vector set) that is closest to the input vector (or vector set).

The vector search engine may be built using known vector search techniques such as, for example, faiss. When this vector search engine is performed based on a GPU, large-capacity, high-speed calculation is possible.

The vector search engine according to the technical idea of the present disclosure may receive a set of features extracted from a target image (e.g., image 1) and in response output the most similar (closest) vector or set of vectors. Further, by determining which image is the source of such a vector or set of vectors, it is possible to determine the mapping image of the target image at high speed.

For example, all of the features extracted from a first image may be input to the vector search engine. The vector search engine may output the vector with the shortest distance from each of the features input in the vector DB or the distance to the vector with the shortest distance. This task may be performed for each image.

For example, assuming that there are five images and 10 features are extracted for each image, 50 vectors may be indexed and stored in the vector DB. Further, information about each source image may be stored together.

The vector search engine may then receive 10 vectors extracted from the first image. Further, the vector search engine may output each of the 10 vectors and 10 vectors with the shortest distance among vectors extracted from a second image or the sum of their distances. If this method is performed on vectors extracted from a third image, vectors extracted from a fourth image, and vectors extracted from a fifth image, it is possible to search for an image including feature sets most similar to the input vector set at high speed. Further, the searched image may be determined as the mapping image of the first image.

According to an embodiment, for each of the 10 vectors output from the first image, the vector search engine may sequentially output vectors having the shortest distances to all vectors (40 vectors) other than the 10 vectors extracted from the first image. For example, when a list of the 10 vectors is output, the automatic phase mapping processing system 100 may analyze the vector list and output the mapping image.

The results or methods output by the vector search engine may vary. However, in any cases, according to the technical idea of the present disclosure, it is possible to extract features from each of the input images and input these features into a DB built to enable vector search and the vector search engine may perform a function of outputting the most similar (closest) vector or vector set upon receiving an input vector or vector set. This function allows mapping images to be searched at high speeds.

According to an embodiment, not all features of the target image, in other words, the image for which the mapping image is to be found (e.g., the first image) may be input, but some features may be input to the vector search engine. For example, only features corresponding to predefined areas in the image may be input to the vector search engine to determine the positional relationship. Since the predefined area may be an area adjacent to the left and right upper and lower corners rather than the center part of the image, an outer area of the image may be arbitrarily set, and a feature at a position corresponding to the set area may optionally be used as input for vector search. Of course, in the vector DB, only features corresponding to this outer area may be input, or all features may be input.

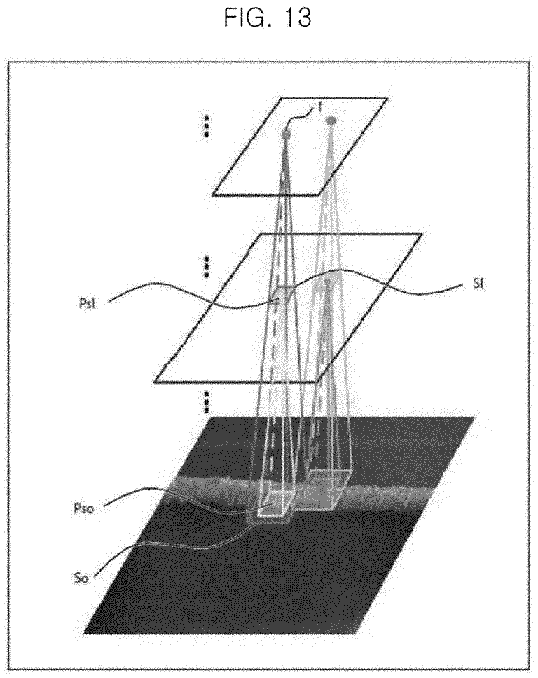

In addition, the neural network feature according to the technical idea of the present disclosure does not by itself specify its position in the extracted image. Therefore, mapping can be performed only when the position (point) in the original image corresponding to the neural network feature is specified. Accordingly, a technical idea of specifying the position on the original image corresponding to the neural network feature is required, which will be described later with reference to FIG. 13.

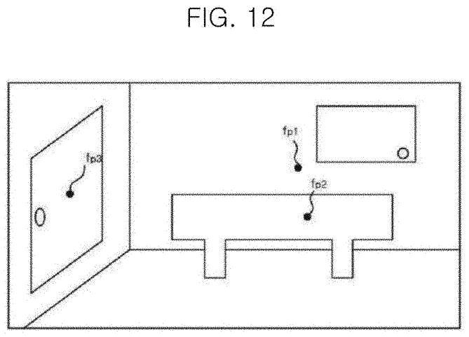

The automatic phase mapping processing system 100 for implementing the technical idea as described above may be defined as a functional or logical configuration as shown in FIG. 11.

FIG. 11 is a diagram for illustrating a logical configuration of an automatic phase mapping processing system according to an embodiment of the present disclosure.

Referring to FIG. 11, the automatic phase mapping processing system 100 according to the technical idea of the present disclosure includes a control module 110, an interface module 120, and a feature extractor 130. The automatic phase mapping processing system 100 may further include a mapping module 140 and/or a vector search engine 150.

The automatic phase mapping processing system 100 may mean a logical configuration having hardware resources and/or software necessary for implementing the technical idea of the present disclosure, and does not necessarily mean one physical component or one device. In other words, the automatic phase mapping processing system 100 may mean a logical combination of hardware and/or software provided to implement the technical idea of the present disclosure, and may be implemented as a set of logical components for implementing the technical idea of the present disclosure by performing respective functions by being installed in devices spaced apart from each other, if necessary. In addition, the automatic phase mapping processing system 100 may mean a set of configurations implemented separately for each function or role for implementing the technical idea of the present disclosure. For example, each of the control module 110, interface module 120, feature extractor 130, mapping module 140, and/or vector search engine 150 may be located in different physical devices or may be located in the same physical device. In addition, according to an implementation example, the combination of software and/or hardware forming each of the control module 110, the interface module 120, the feature extractor 130, the mapping module 140, and/or the vector search engine 150 may also be located in different physical devices, and configurations located in different physical devices may be organically combined with each other to implement each of the modules.

The control module 110 may control other elements included in the automatic phase mapping processing system 100 (e.g., the interface module 120, feature extractor 130, mapping module 140, and/or vector search engine 150, etc.) to implement the technical idea of the present disclosure.

The interface module 120 may receive a plurality of images from the outside. The plurality of images may be images shot at different positions. According to one example, the plurality of images may be omnidirectional images shot indoors, but are not limited thereto.

Among the plurality of images, there may be ones that have been shot in different positions in a common space, and two images including the common space, in other words, the common area, may be defined as having a mappable relationship. Among them, an image containing the largest number of common areas may be defined as the mapping image, which may be defined as images with the largest number of corresponding features.

From each of the plurality of images input through the interface module 120, the feature extractor 130 may extract the feature defined according to the technical idea of the present disclosure, in other words, the neural network feature.

As described above, the neural network features may be features of an image specified prior to the output layer in a given neural network (e.g., CNN). The feature extractor 130 may be the neural network 20 itself as shown in FIG. 10A, and may refer to a configuration from the input layer 21 to a predetermined layer (e.g., 23) prior to the output layer 24 in the neural network. All or a part of the features included in the feature map defined by the layer 23 may be neural network features.

The neural network 20 may be trained for a separate purpose (e.g., classification, detection, etc.) other than the purpose of extracting the neural network feature, but as described above, may be a neural network designed to match two images with minimal error or may be trained for the purpose of extracting neural network features.

For example, the latter may be trained to output a handcraft feature point that well represents a position and/or image characteristic arbitrarily set by a user, and in this case, the neural network 20 itself may be the feature extractor 130.

The position arbitrarily set by the user may be, in a predetermined object (e.g., a wall, a door, etc.), a position set by the user (e.g., the center position of the object). In addition, this position set by the user can be set in a flat area, in other words, a flat image area where there are no edges or corners, unlike conventional handcraft feature points. In this case, the feature can be defined even within the flat image area that is not extracted as a feature point according to the conventional handcraft feature point, and when using this, it is possible to perform determination and mapping of the mapping image more accurately.

FIG. 12 is a diagram for illustrating advantages of using the neural network feature according to an embodiment of the present disclosure.

As shown in FIG. 12, the feature extractor 130 may be trained to specify any positions in predetermined objects (e.g., a wall, door, and table) as feature points fp1, fp2, and fp3.

In addition, as shown in FIG. 12, the positions may be set within a typically flat image area, such as a predetermined position for each object (e.g., a center of the wall, a center of the table, a center of the door, etc.).

Of course, the feature extractor 130 may be trained to extract a feature corresponding to the handcraft feature point, such as an edge or a corner bent as conventionally.

For example, the user may annotate handcraft feature points and setting positions of flat areas set by the user for each object in a plurality of images, and use them as training data to train the neural network 20. In this case, features corresponding to each of the feature points fp1, p2, and fp3 may be extracted, and the feature point itself may be output.

In any case, when using the neural network feature, a position that is not extracted by the conventional handcraft feature may be utilized as the feature, as shown in FIG. 5, so that it may have an advantageous effect on defining image characteristics or mapping an image.

On the other hand, although the neural network feature is characteristic information of an image determined through a plurality of convolutions and/or pooling to output a desired purpose by the neural network 20, such a neural network feature itself may not represent a specific position in the corresponding original image.

Therefore, even when the neural network feature is extracted, the position on the original image corresponding to the neural network feature, in other words, the feature position, needs to be specified. This is because image mapping can be performed only when this feature position is specified.

As such, the technical idea of specifying the feature position of the neural network feature will be described with reference to FIG. 13.

FIG. 13 is a diagram for illustrating a feature position corresponding to a neural network feature according to an embodiment of the present disclosure.

As shown in FIG. 13, a neural network feature f may be extracted from a given layer. In this case, the neural network feature f corresponds to a predetermined corresponding area Sl in a previous predetermined layer 1, and pixel information included in the corresponding area Sl may be mapped to the neural network feature f by a predefined convolutional and pooling function.

In this case, a predetermined position (e.g., a center or a specific vertex, etc.) in the corresponding area Sl of the neural network feature fin the l layer may be defined as a corresponding position PSl in the l layer of the neural network feature f.

Then, in the same manner, a corresponding area So on the original image corresponding to the corresponding position PSl in the l layer may be specified by the convolution and pooling relationship between the original image and the l layer, and a predetermined position (e.g., center) in the corresponding area So may be specified as a corresponding position on the original image of the neural network feature f, in other words, the feature position.

In this way, if the feature position is determined for each neural network feature, each feature position may be a feature point for image mapping.

The mapping module 140 may then perform image mapping using corresponding feature positions between the mapping images.

Image mapping between two images may be performed using points corresponding to each other in each of the two images in the case of mapping that specifies the relative positional relationship between the two images. In this case, the points corresponding to each other may be feature points of the neural network feature extracted from each of the two images, and the corresponding feature points may be easily searched through the vector search engine.

When the points corresponding to each other (representing the same position in space) are present in different images, technical ideas for specifying the relative positional relationship of these two images have been known.

For example, an average expert in the art of the present disclosure can easily infer that the relative positional relationship may be determined using Epipolar Geometry. There may be many other possible approaches.

According to another embodiment, when mapping between two images, i.e., mapping images, matches two images, specifying a transformation matrix for matching the two images may be performing the mapping.

It is widely known that in order to specify such a transformation matrix, three pairs of features corresponding to each other may be extracted and a transformation matrix may be defined so that the extracted three pairs may be transformed. Thus, these three pairs of features may be searched so that all features may be transformed with the smallest error, and, or course, algorithms such as RANSAC may be used.

The vector search engine 150 may input vectors corresponding to the features of each image extracted by the feature extractor 130 to the DB as described above, and receive a vector set corresponding to the feature set extracted from the target image (e.g., the first image). Then, as described above, a vector search result may be output.

The control module 110 may then determine an image existing in a positional relationship adjacent to the target image based on the vector search result.

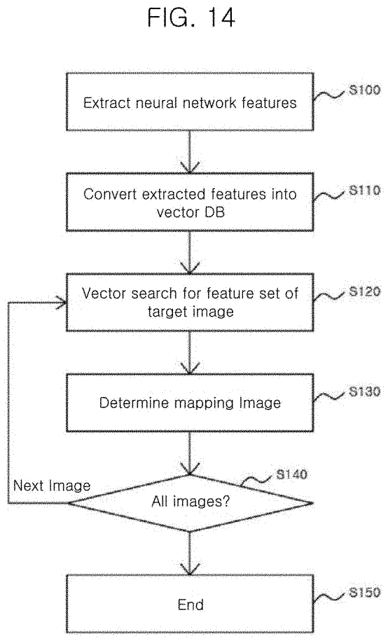

FIG. 14 is a flowchart for illustrating a method of searching for mapping images between images in the automatic phase mapping processing method according to an embodiment of the present disclosure.

Referring to FIG. 14, the automatic phase mapping processing system 100 according to the technical idea of the present disclosure may extract the neural network feature from each of a plurality of images (S100). The features are then be built into the vector DB and vector search may be performed on the vector set (feature set) extracted from the target image (S110, S120).

Then, a mapping image of the target image may be determined based on the vector search result (S130), and a mapping image of each image may be determined by performing the same task on all images (S140).

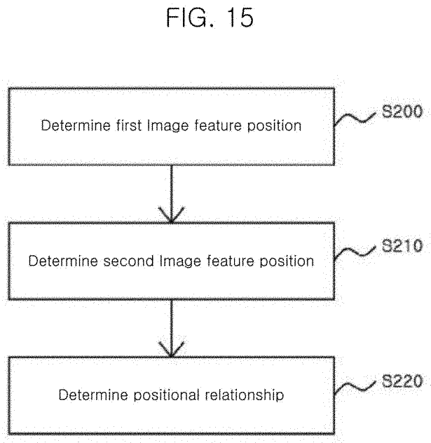

FIG. 15 is a flowchart for illustrating a method of mapping images in the automatic phase mapping processing method according to an embodiment of the present disclosure.

Referring to FIG. 15, the automatic phase mapping processing system 100 according to the technical idea of the present disclosure may specify feature positions corresponding to the features extracted from the first image to map the first image and the second image determined as the mapping images to each other (S200). To this end, the same method as shown in FIG. 13 may be used.

In addition, feature positions corresponding to the features extracted from the second image may be specified (S210).

The automatic phase mapping processing system 100 may then determine a relative positional relationship through an Epipolar Geometry algorithm based on the feature positions of each image, or determine a transformation matrix for image connection through a predetermined method (e.g., RANSAC algorithm) (S220).

Referring again to FIG. 6, the server 100 may place the plurality of omnidirectional images corresponding to each of the different positions of the indoor space on a floor plan corresponding to the indoor space (S30).

More specifically, the server 100 may acquire the floor plan corresponding to the indoor space. For example, the server 100 may receive the floor plan 10 as shown in FIG. 6 in the form of a file.

Thereafter, the server 100 may receive a first point on the floor plan corresponding to first position information included in first information set, which is any one of the plurality of information sets, and a second point on the floor plan corresponding to second position information set included in second information set, which is another of the plurality of information sets. For example, the server 100 may receive coordinates on the floor plan 10 corresponding to the position 11 and coordinates on the plan view 10 corresponding to the position 12.

Then, the server 100 may place the plurality of omnidirectional images on the floor plan based on a positional relationship between a first position represented by the first position information and a second position represented by the second position information, and a positional relationship between the first point and the second point.

As described above, the server 100 may know the relative positional relationship between the omnidirectional images corresponding to each position by the above-described automatic phase mapping processing method. Therefore, the server may calculate a predetermined parameter such that the positional relationship between the first and second points (for example, the distance and direction between the two points) match the positional relationship between the first and second positions and apply it to relative positions between the positions calculated by the automatic phase mapping method described above, to determine positions on the floor plan where the plurality of omnidirectional images are to be placed.

The method according to an embodiment of the present disclosure may be implemented in the form of computer-readable program instructions and stored in a non-transitory computer-readable recording medium. The non-transitory computer-readable recording medium includes all kinds of recording devices in which data that can be read by a computer system is stored.

Program instructions recorded in a recording medium may be those specifically designed and configured for the present disclosure or may be known and available to those skilled in the art of software.

Examples of computer-readable recording media include magnetic media such as hard disks, floppy disks, and magnetic tapes, optical media such as CD-ROMs and DVDs, magneto-optical media such as floptic disks, and hardware devices specifically configured to store and execute program instructions such as ROM, RAM, flash memory, and the like. In addition, the computer-readable recording medium is distributed in a networked computer system, so computer-readable codes can be stored and executed in a distributed manner.

Examples of program instructions include machine language code, such as those produced by compilers, as well as high-level language code that can be executed by devices that process information electronically using interpreters or the like, such as computers, for example.

The hardware devices described above may be configured to operate as one or more software modules to perform the operations of the present disclosure, and vice versa.

The description of the present disclosure as above is for illustrative purposes only, and those skilled in the art to which the present disclosure pertains will understand that it can be easily modified into other specific forms without changing the technical spirit or essential features of the present disclosure.

Therefore, it should be understood that the embodiments described above are illustrative and not limiting in all respects. For example, each component described as a single form may be implemented in a distributed manner, and similarly, components described as distributed may also be implemented in a combined form.

The scope of the present disclosure is indicated by the following claims rather than the detailed description above, and all changes or modifications derived from the spirit and scope of the claims and equivalent concepts thereof should be construed as being included in the scope of the present disclosure.

The present disclosure may be used for an omnidirectional image capturing assembly and a method performed thereby.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

1. An omnidirectional image capturing assembly comprising:
an omnidirectional image capturing apparatus;
a mobile computing apparatus; and
a movable holder for fixing the omnidirectional image capturing apparatus and the mobile computing apparatus,
wherein the mobile computing apparatus comprises:
a communication module for communicating with the omnidirectional image capturing apparatus;
a tracking module configured to track a position of the mobile computing apparatus;
a control module configured to acquire, when an image is shot by the omnidirectional image capturing apparatus, position information of the mobile computing apparatus at the time of shooting; and
a storage module configured to store a shot image shot by the omnidirectional image capturing apparatus and the position information of the mobile computing apparatus at the time of shooting of the shot image.

2. The omnidirectional image capturing assembly of claim 1, wherein the tracking module is configured to further track a posture of the mobile computing apparatus,
the control module is configured to acquire, when the image is shot by the omnidirectional image capturing apparatus, posture information of the mobile computing apparatus at the time of shooting, and
the storage module is configured to further store the posture information of the mobile computing apparatus at the time of shooting of the shot image.

3. The omnidirectional image capturing assembly of claim 2, wherein the mobile computing apparatus comprises a camera module,
the omnidirectional image capturing apparatus and the mobile computing apparatus are installed on the movable holder such that a shooting direction of a front camera module included in the omnidirectional image capturing apparatus and a shooting direction of the camera module included in the mobile computing apparatus coincide within a predetermined error range, and
the tracking module is configured to track the position and posture of the mobile computing apparatus by performing Visual Simultaneous Localization and Mapping (VSLAM) on an image shot by the camera module.

4. The omnidirectional image capturing assembly of claim 1, wherein the mobile computing apparatus further comprises a transmission module configured to transmit to a predetermined server an information set including an omnidirectional image generated by stitching a plurality of partial shot images shot by the omnidirectional image capturing apparatus and position information of the mobile computing apparatus at the time when the plurality of partial shot images are shot, and
the server is configured to determine, when receiving a plurality of information sets corresponding to different positions within a predetermined indoor space from the mobile computing apparatus, a connection relationship between a plurality of omnidirectional images included in the plurality of information sets wherein at least two of the plurality of omnidirectional images have a common area in which a common space is shot.

5. The omnidirectional image capturing assembly of claim 1, wherein the mobile computing apparatus further comprises a transmission module configured to transmit to a predetermined server an information set including a plurality of partial shot images shot by the omnidirectional image capturing apparatus and position information of the mobile computing apparatus at the time when the plurality of partial shot images are shot, and
the server is configured to generate an omnidirectional image corresponding to the information set when receiving the information set from the mobile computing apparatus, by stitching the plurality of partial shot images included in the information set, and
when receiving a plurality of information sets corresponding to different positions in a predetermined indoor space from the mobile computing apparatus to generate an omnidirectional image corresponding to each of the plurality of information sets corresponding to the different positions in the indoor space, determine a connection relationship between the plurality of omnidirectional images, wherein at least two of the plurality of omnidirectional images have a common area in which a common space is shot.

6. The omnidirectional image capturing assembly of claim 5, wherein the server is configured to extract features from each of the plurality of omnidirectional images through a feature extractor using a neural network and determine a mapping image of each of the plurality of omnidirectional images based on the features extracted from each of the plurality of omnidirectional images, in order to determine the connection relationship between the plurality of omnidirectional images.

7. The omnidirectional image capturing assembly of claim 5, wherein the information set is in the form of JavaScript Object Notation.

8. The omnidirectional image capturing assembly of claim 1, wherein the mobile computing apparatus is installed on a rotating body rotating with a mounting rod of the movable holder as a rotating axis, and further comprises:
a camera module; and
a rotating body control module configured to control rotation of the rotating body, and
the rotating body control module is configured to control the rotation of the rotating body such that a shooting direction of a front camera module included in the omnidirectional image capturing apparatus and a shooting direction of the camera module included in the mobile computing apparatus coincide within a predetermined error range.

9. The omnidirectional image capturing assembly of claim 8, wherein the rotating body control module is configured to control the rotation of the rotating body based on an image shot by the front camera module included in the omnidirectional image capturing apparatus and an image shot by the camera module included in the mobile computing apparatus.

10. A mobile computing apparatus installed on a movable holder, comprising:
a communication module for communicating with an omnidirectional image capturing apparatus installed on the movable holder;
a tracking module configured to track a position of the mobile computing apparatus;
a control module configured to acquire, when an image is shot by the omnidirectional image capturing apparatus, position information of the mobile computing apparatus at the time of shooting; and
a storage module configured to store a shot image shot by the omnidirectional image capturing apparatus and the position information of the mobile computing apparatus at the time of shooting of the shot image.

11. A method performed by a mobile computing apparatus installed on a movable holder, the method comprising:
an operation of establishing connection for wireless communication with an omnidirectional image capturing apparatus installed on the movable holder;
a tracking operation of tracking a position of the mobile computing apparatus;
an information acquisition operation of acquiring, when an image is shot by the omnidirectional image capturing apparatus, position information of the mobile computing apparatus at the time of shooting; and
a storage operation of storing a shot image shot by the omnidirectional image capturing apparatus and the position information of the mobile computing apparatus at the time of shooting of the shot image.

12. The method of claim 11, wherein the tracking operation comprises tracking a posture of the mobile computing apparatus,
the information acquisition operation comprises acquiring, when the image is shot by the omnidirectional image capturing apparatus, posture information of the mobile computing apparatus at the time of shooting, and
the storage operation comprises storing the posture information of the mobile computing apparatus at the time of shooting of the shot image.

13. The method of claim 12, wherein the mobile computing apparatus comprises a camera module,
the omnidirectional image capturing apparatus and the mobile computing apparatus are installed on the movable holder such that a shooting direction of a front camera module included in the omnidirectional image capturing apparatus and a shooting direction of the camera module included in the mobile computing apparatus coincide within a predetermined error range, and
the tracking operation comprises tracking the position and posture of the mobile computing apparatus by performing Visual Simultaneous Localization and Mapping (VSLAM) on an image shot by the camera module.

14. The method of claim 11, wherein the method further comprises transmitting to a predetermined server an omnidirectional image generated by stitching a plurality of partial shot images shot by the omnidirectional image capturing apparatus and an information set including position information of the mobile computing apparatus at the time when the plurality of partial shot images are shot, and
the server is configured to determine, when receiving from the mobile computing apparatus a plurality of information sets corresponding to different positions in a predetermined indoor space, a connection relationship between a plurality of omnidirectional images included in the plurality of information sets, wherein at least two of the plurality of omnidirectional images have a common area in which a common space is shot.

15. The method of claim 11, wherein the method further comprises transmitting to a predetermined server an information set including a plurality of partial shot images shot by the omnidirectional image capturing apparatus and the position information of the mobile computing apparatus at the time of shooting of the plurality of partial shot images, and
the server is configured to generate an omnidirectional image corresponding to the information set when receiving the information set from the mobile computing apparatus, by stitching the plurality of partial shot images included in the information set, and
when receiving a plurality of information sets corresponding to different positions in a predetermined indoor space from the mobile computing apparatus to generate an omnidirectional image corresponding to each of the plurality of information sets corresponding to the different positions in the indoor space, determine a connection relationship between the plurality of omnidirectional images, wherein at least two of the plurality of omnidirectional images have a common area in which a common space is shot.

16. The method of claim 11, wherein the mobile computing apparatus is installed on a rotating body rotating with a mounting rod of the movable holder as a rotating axis,
the mobile computing apparatus comprises a camera module, and
the method further comprises a rotating body control operation of controlling rotation of the rotating body, and
wherein the rotating body control operation comprises controlling the rotation of the rotating body such that a shooting direction of a front camera module included in the omnidirectional image capturing apparatus and a shooting direction of the camera module included in the mobile computing apparatus coincide within a predetermined error range.

17. The method of claim 16, wherein the rotating body control operation comprises controlling the rotation of the rotating body based on an image shot by the front camera module included in the omnidirectional image capturing apparatus and an image shot by the camera module included in the mobile computing apparatus.

18. A non-transitory computer-readable recording medium in which a program for performing the method of claim 11 is recorded.

19. A mobile computing apparatus comprising:
a processor; and
a memory in which a program is stored,
wherein the program, when executed by the processor, causes the mobile computing apparatus to perform the method of claim 11.
